(19) United States
(12) Patent Application Publication
(10) Pub. No.: US 2017/0137202 A1
(43) Pub. Date: May 18, 2017

(54) RESEALABLE RIGID MODIFIED ATMOSPHERE PACKAGING WITH LAMINATED SEALANT LAYER

(71) Applicant: Nicholas J DaCosta, Carmel, CA (US)

(72) Inventor: Nicholas J DaCosta, Carmel, CA (US)

(21) Appl. No.: 14/941,028

(22) Filed: Nov. 13, 2015

(51) Int. Cl. B65D 81/26; B65D 1/36; B23B 41/14; B65D 65/40

(52) U.S. Cl. CPC B65D 81/263; B65D 65/40; B65D 1/36; B23B 41/14; B23B 2228/36; B23B 2251/426; B23B 2260/092; B23B 2260/128

(57) ABSTRACT

A rigid or semi-rigid MAP container includes microperforations at least 0.4 mm in length, with diameters between 20 and 300 microns that are uniform within +/−10% through both the laminated rigid/semi-rigid and sealant layers of the container. The microperforations are created using one or more micro-drills rather than a laser. A backing support can be used to inhibit container deformation during drilling. The laminate can include an outer PET layer, and/or an inner sealant layer that includes polyacrylonitrile resin and/or polyester film. Initially, the lid is hermetically sealed to the base by the sealant layers, and is mechanically resealable to the base after initial use. The microperforations can be widely distributed or concentrated in “target areas.” The base can be divided into compartments that are in gas communication with each other or hermetically isolated with separate configurations of microperforations that are optimal for the expected contents of each compartment.

### FIELD OF THE INVENTION

The invention relates to packaging, and more particularly, to modified atmosphere packaging.

### BACKGROUND OF THE INVENTION

The quality and shelf-life of many perishable products is critically dependent on the nature and quality of the packaging in which it is contained. For many food products, such as meats and cheeses, optimal preservation is obtained by removing as much atmosphere as possible and hermetically sealing the product. However, other food products, such as produce, continue to undergo respiration while being transported and stored, and will quickly perish and spoil if placed in a hermetically sealed container.

One approach is to use packing that is well ventilated, so that the atmosphere within the container approximates the ambient atmosphere, thereby allowing unimpeded respiration by the contained produce while it is transported and stored. This approach avoids the premature spoilage that can result from hermetic packaging, but does nothing to enhance or prolong the quality and shelf life of the produce beyond what would be obtained if the produce were not contained in a package.

Another approach is to enclose produce in packaging that allows only a very limited rate of gas exchange between the interior of the package and the surrounding environment. By tailoring the gas exchange rate to the specific type and quantity of contained produce, and taking into account the temperature and other factors, it is possible to induce a modified atmosphere within the package, whereby the oxygen level is reduced and the carbon dioxide level is increased, thereby slowing the metabolism of the produce and extending its shelf life without causing the contained produce to perish and spoil. This approach is generally referred to as modified atmosphere packaging (“MAP”). The result can be increased quality and longer shelf life, less waste from spoiled produce, better inventory control, and appreciable overall savings for the food industry at both the retail and wholesale levels.

MAP can be implemented in any of several ways. In some instances, MAP can be achieved simply by selecting an appropriate packaging material and controlling the thickness of the material so as to provide a limited permeability to oxygen and carbon dioxide. However, this approach places significant constraints on package size, packaging material, overall package strength and durability, and packaging costs. It is therefore applicable only to a limited range of circumstances.

Another approach is to use a packaging material that is essentially impermeable to gases, and to penetrate the material with one or more “microperforations,” typically having diameters measuring in the tens of microns to hundreds of microns. In this way, an optimal packaging material, and desired package size and type can be selected, and then the number, size, and placement of the micro-perforations can be adjusted so as to provide an optimal modified atmosphere for the enclosed type and quantity of produce.

While the microperforation approach to MAP has many advantages, the technology required to provide precise and consistent microperforations can be difficult and expensive to implement. Most practical implementations of MAP have depended on microperforation of a thin film or web, since these materials are easier to puncture, either with pins or with a relatively low power laser. Depending on the application, a flexible package may be constructed entirely from the microperforated web, which can be uniformly perforated, or perforated only in one more isolated “target areas.” If a more durable solution is required, a flexible package made from a microperforated web can be placed in an outer carton having large ventilation holes, and in some cases the ventilation holes can be provided in locations where they are likely to align with microperforated target areas. Nevertheless, this approach can be expensive, at least due to the requirement to provide both an inner bag and an outer carton, and it is susceptible to occlusion of the microperforations by the outer carton.

Yet another approach is to contain the produce in a rigid or semi-rigid package having an open top, and to seal the top with a microperforated film or web. This approach is effective for packages that are intended for single use, but the approach is problematic for applications where it is desirable to re-seal the package after initial use and to reestablish a modified atmosphere to prolong the shelf life of the remaining contents.

Some attempts have been made to provide a rigid or semi-rigid package with a re-sealable, rigid or semi-rigid lid that can provide a modified atmosphere for contained produce. It is typically not practical to microperforate a rigid or semi-rigid package using pins, because a pin that is strong enough to puncture a rigid or semi-rigid packaging wall is generally too large in diameter to be useful for modified atmosphere packaging. One approach is to provide a macroscopic opening in the rigid lid or the rigid base, and then cover the opening with a section of microperforated film or web. However, this approach is somewhat complex and costly because of the need to prepare and assemble at least three separate components.

With reference to FIGS. 1A and 1B, another approach is to provide a container 100 having a rigid base 102 and a rigid lid 104, and to use a powerful laser to burn microperforations 106 through the rigid material of the base 102 (FIG. 1A) and/or lid 104 (FIG. 1B). However, high power lasers sufficient for rapidly burning microperforations in rigid and semi-rigid materials are costly, and somewhat dangerous to operate. High power lasers can also suffer from focal errors that can degrade their calibration and the resulting precision of the microperforation diameters. Also, toxic vapors may result from the burning of the relatively thick packaging material.

Laser perforation of rigid packaging can be even more problematic if the rigid packaging is laminated or coated with a separate, heat-activated sealant layer. With reference to FIGS. 2A through 2C, it is sometimes advantageous to form a rigid or semi-rigid base 200 and lid 202 using a laminated material 204 having a rigid or semi-rigid outer layer 206 and an inner sealant layer 208 laminated thereto. Initially, such packaging 210 can be hermetically sealed by application of heat, thereby extending shelf life during transportation and storage. Once the seal is broken and the package 210 is opened by a consumer, and after partial consumption of the contents, the package 210 can be mechanically re-sealed in the same manner as the container 100 of FIG. 1A.

For modified atmosphere packaging, this type of rigid container 210 with laminated sealant layer 208 is attractive, because it excludes any possibility of unintended gas exchange during transport and pre-sale storage due to imperfect sealing of the lid 202 to the base 200. However, with reference to FIGS. 3A through 3B, laser perforation of such packaging is problematic, because for such thicker, rigid or semi-rigid package walls 206, the microperforations 300 created by the laser tend to be non-uniform in diameter, so that their diameters can be difficult to accurately control. Furthermore, the sealant layer 208 is sensitive to heat, since it is designed to form a seal when heated. Accordingly, when the sealant layer is exposed to the heat of the laser, it may flow or melt 302 and thereby partially or fully occlude the microperforations 300, and/or the sealant layer 208 may recede or even burn away 304 from the microperforations 300, vaporize, and deposit toxic dust in the container 210 that may pose a health hazard if it comes into contact with whatever produce is subsequently placed within the package.

What is needed, therefore, is a rigid, microperforated, modified atmosphere packaging container having a laminated sealant layer, wherein the container includes accurately reproducible microperforations with diameters in the range of 20 to 300 microns, the microperforations being uniform in diameter through both the rigid layer and the sealant layer of the container. What is further needed is a method of producing such a container.

### SUMMARY OF THE INVENTION

A rigid, microperforated, modified atmosphere packaging container including a sealant layer is disclosed, as well as a method of producing the container, wherein the container includes accurately reproducible microperforations with diameters in the range of 20 to 300 microns, preferably between 40 and 250 microns, and wherein the microperforations are uniform in diameter within a tolerance of 10% along their lengths through both the rigid layer and the sealant layer of the container.

Rather than using a laser to create the one or more microperforations, the present invention uses micro-drills to create perforations of uniform diameter through both the rigid layer, which in embodiments is PET, and the sealant layer, which is various embodiments is polyacrylonitrile resin or polyester film. Depending on the application, the diameters of the microperforations are in the range of 20 microns to 300 microns, and preferably between 40 microns and 250 microns, with a hole diameter uniformity of better than plus or minus 10%.

The juncture between the lid and body of the disclosed container can be hermetically sealed during initial packaging by an appropriate combination of heat, pressure, and dwell time, so that the only gas exchange is through the accurately dimensioned microperforations. The one or more microperforations can be located in the base and/or lid of the container, and can be distributed in any convenient manner, including widely separated microperforations and/or microperforations concentrated in one or more “target areas.”

In some embodiments of the disclosed method, a backing support is temporarily positioned behind the wall or lid of the container in the region to be microperforated by the micro-drill. The backing support can be made from any convenient material, and can include a clearance hole to avoid contact with the micro-drill. In an automated, assembly-line production environment, each container lid or base is brought to a drilling station, its position is “registered” (for example by a low power laser and optical sensor), and the backing support is lowered into position. The microperforation(s) is/are then drilled, either by a single drill or by a plurality of drills acting simultaneously. The drill(s) and/or container lid or base can be moved after the initial drilling, and the drilling process can be repeated so as to provide the desired number of microperforations.

Embodiments of the present invention include internal wells or compartments that can be filled with differing contents. In some of these embodiments, the compartments are separated by partitions that rise to a level slightly below the lid, for example 1-2 mm below the lid, so that the contents are maintained in their respective compartments but air is able to flow throughout the package interior. In other of these embodiments, the partitions that divide the compartments extend to the lid, so that upon initial packaging the partitions are sealed to the lid by the sealant layers, creating hermetically isolated compartments that can each be ventilated by a customized configuration of microperforations so as to provide separately determined modified atmospheres in each of the compartments that are optimized for the intended contents thereof. Compartments intended to contain meat, cheese, dip, or some other content that does not benefit from respiration can be left without microperforations, so that the compartments are hermetically sealed.

One general aspect of the present invention is a rigid or semi-rigid container configured for modified atmosphere packaging of produce. The container includes a base and a lid, the lid being removably engageable and reengagable with the base so as to form a seal therebetween, the base and lid both being formed from laminated panels having outer rigid or semi-rigid layers laminated to inner sealant layers, the sealant layers being sealable to each other so as to form a hermetically sealed junction between the lid and the base. The container further includes at least one microperforation penetrating both laminated layers of one of the base and the lid, said microperforation having a length of at least 0.4 mm and a diameter between 20 microns and 300 microns, said diameter being uniform along a length of the microperforation within a tolerance of plus or minus 10%.

In embodiments, the outer layer of the laminated panel include PET, and/or the inner layer of the laminated panel includes at least one of polyacrylonitrile resin and polyester film. In certain embodiments, the diameter of the at least one microperforation is between 40 microns and 250 microns.

In various embodiments, the base of the container is divided by partitions into a plurality of compartments. In some of these embodiments, a gap of at least 0.5 mm remains between tops of the partitions and the lid when the lid is engaged with the base. In other of these embodiments, the sealant layers on tops of the partitions are hermetically sealed to the sealant layer of the lid when the lid is engaged and sealed with the base, and the compartments are thereby hermetically isolated from each other. In some of these embodiments a rate of gas exchange between each compartment and a surrounding ambient atmosphere is separately controlled according to a number and configuration of microperforations provided in the compartment. And in some of these embodiments at least one of the compartments is hermetically isolated from the surrounding ambient atmosphere.

In embodiments, the container includes a plurality of microperforations. And in some of these embodiments, the plurality of microperforations are located in at least one localized target area on at least one of the base or lid, a largest dimension of said target areas being no greater than 25% of a smallest of a height, a width, and a depth of said container.

Another general aspect of the present invention is a method for manufacturing a rigid or semi-rigid container configured for modified atmosphere packaging of produce. The method includes providing a base and a lid, the lid being removably engageable and reengagable with the base so as to form a seal therebetween, the base and lid both being formed from laminated panels having outer rigid or semi-rigid layers laminated to inner sealant layers, the sealant layers being sealable to each other so as to form a hermetically sealed junction between the lid and the base. The method further includes using a micro-drill to drill at least one microperforation through both laminated layers of one of the base and the lid, said microperforation having a length of at least 0.4 mm and said micro-drill having a diameter between 20 microns and 300 microns.

Embodiments further include, before drilling said at least one microperforation, locating a rigid backing support behind at least a localized region of the base or lid where the microperforation is to be drilled so as to inhibit the base or lid from deforming during the drilling of the microperforation.

Some embodiments further includes conveying the lid or base to a drilling station, and registering a location of the lid or base, so that the location is accurately determined. And in some of these embodiments registering the location of the lid or base includes using at least one of a laser and a light sensor.

Various embodiments further include drilling a plurality of microperforations using a plurality of micro-drills, each of the microperforation having a length of at least 0.4 mm, each of the micro-drills having a diameter between 20 and 300 microns.

And certain embodiments further include moving at least one of the base or lid and the micro-drill, and drilling at least one more microperforation.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a perspective view of a semi-rigid modified atmosphere packaging container of the prior art;

FIG. 1B is a top view of the lid of FIG. 1A;

FIG. 2A is a cross sectional view of a sealant laminated panel used in container of the prior art and of the present invention;

FIG. 2B is a cross sectional view of a container made from the panel of FIG. 2A, shown with the lid separated from the base;

FIG. 2C is a cross sectional view of a container made from the panel of FIG. 2A, shown with the lid hermetically sealed to the base;

FIG. 3A is a cross sectional view of a microperforation of the container of FIG. 2B, the microperforation being formed using a laser according to the prior art, wherein the sealant layer has melted and constricted the diameter of the microperforation;

FIG. 3B is a cross sectional view of a microperforation of the container of FIG. 2B, the microperforation being formed using a laser according to the prior art, wherein the sealant layer has burned away from the microperforation, thereby releasing toxic gases and particulates;

FIG. 3C is a cross sectional view of a microperforation of the container of FIG. 2B, the microperforation being formed using a micro-drill according to an embodiment of the present invention;

FIG. 4A is a cross sectional view showing a micro-drill positioned to drill a microperforation through a side wall of a container base according to an embodiment of the present invention, the side wall being supported by a backing support panel;

FIG. 4B is a perspective view of the backing support panel of FIG. 4A, showing a clearance hole provided therein;

FIG. 5 is a flow diagram illustrating a method embodiment of the present invention;

FIG. 6A is a perspective view of a container base that includes a plurality of separately microperforated compartments divided by partition walls according to an embodiment of the present invention; and

FIG. 6B is a side view of the container base of FIG. 6A having a lid attached thereto.

### DETAILED DESCRIPTION

The present invention is a rigid or semi-rigid, microperforated, modified atmosphere packaging container including a laminated sealant layer, as well as a method of making the container, wherein the container includes accurately reproducible microperforations with diameters in the range of 20 to 300 microns, preferably 40 to 250 microns, and wherein the microperforations are uniform in diameter throughout their lengths within a tolerance of plus or minus 10% through both through the rigid layer and the sealant layer of the container laminate.

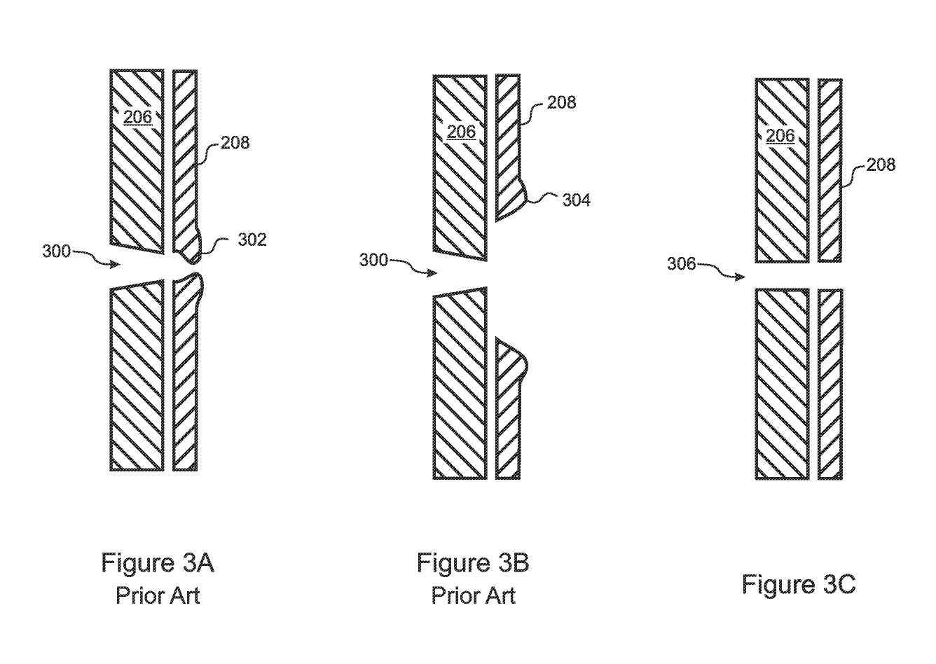

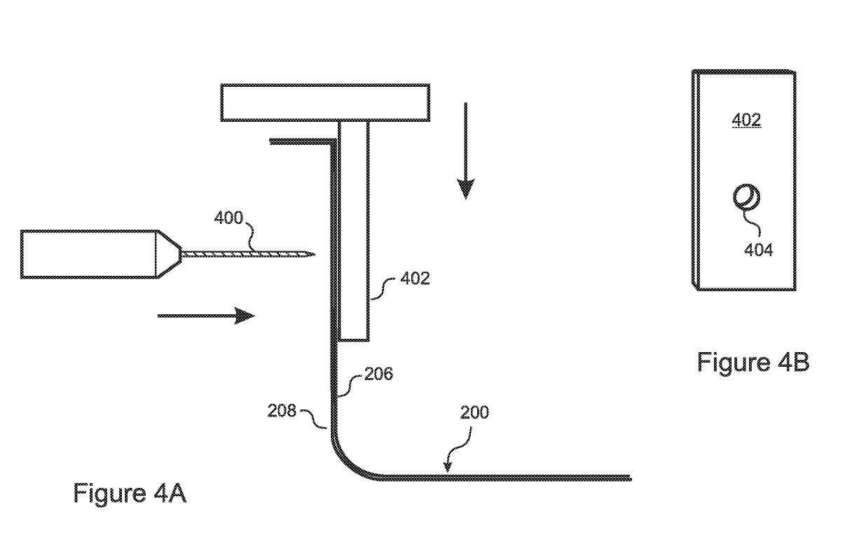

As illustrated in FIGS. 3A and 3B, using a laser to create the one or more microperforations can lead to non-uniform perforation diameters 300, clogging by melted sealant 302, and/or burning of the sealant 304 and potential contamination of the contents by particulates. Rather than using a laser, with reference to FIGS. 3C and 4, the present invention uses one or more micro-drills 400 to create microperforations of uniform diameter 306 through both the rigid or semi-rigid layer 206, which in embodiments is PET, and the sealant layer 208, which is various embodiments is polyacrylonitrile resin or polyester film. compared to a laser, the micro-drill generates very little heat, and is able to drill through the sealant layer without causing any degradation thereof. Depending on the application, the diameters of the microperforations 306 are in the range of 20 microns to 300 microns, and preferably from 40 microns to 250 microns, with a microperforation diameter uniformity of better than plus or minus 10% long the lengths of the microperforations 306.

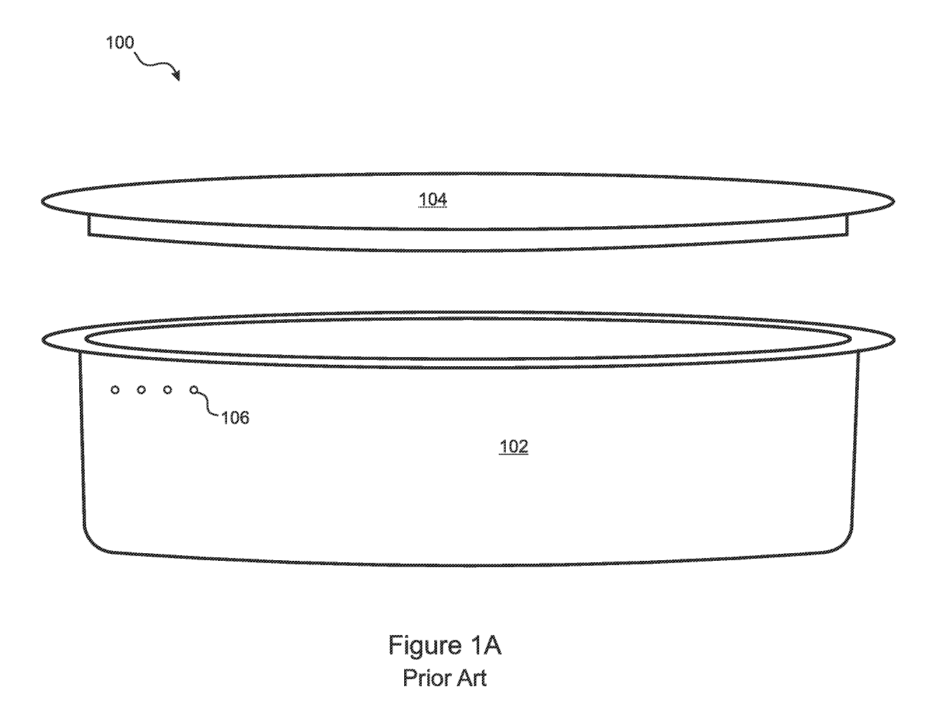

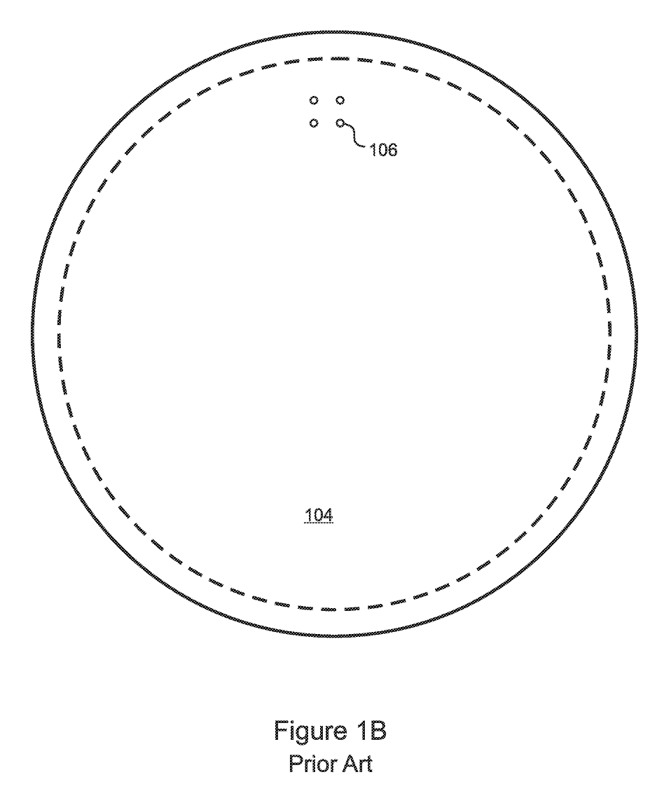

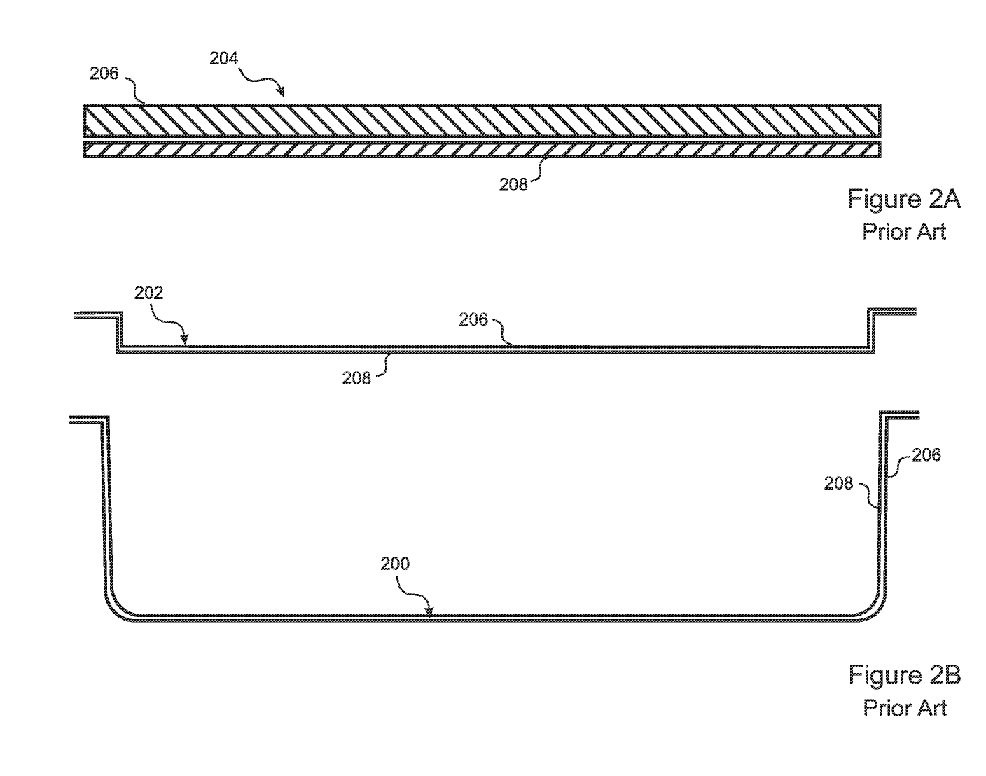

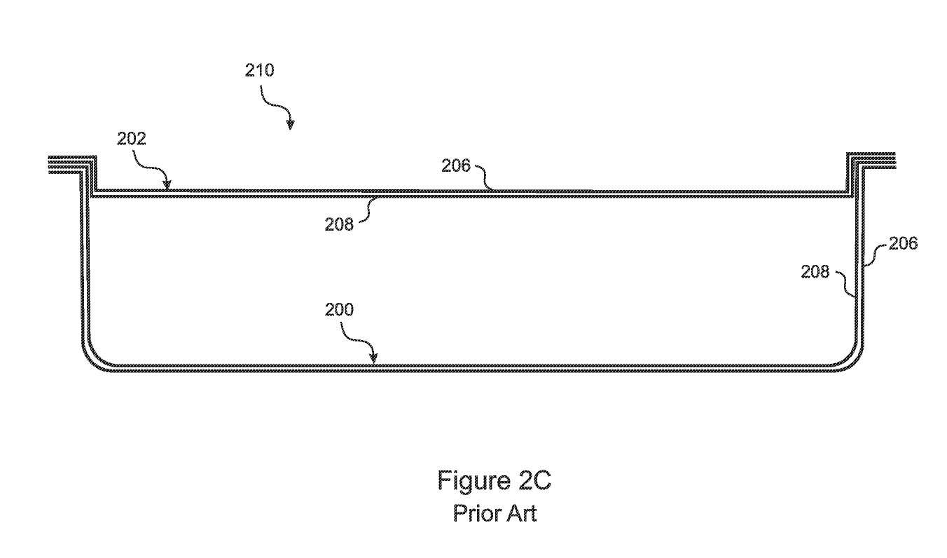

The juncture between the lid 202 and body 200 of the disclosed container can be hermetically sealed during initial packaging by an appropriate combination of heat, pressure, and dwell time, so that the only gas exchange is through the accurately dimensioned microperforations 306. The one or more microperforations 306 can be located in the base 200 of the container, as shown in FIG. 1A, and/or in the lid 202 of the container, as shown in FIG. 1B, and can be distributed throughout the container in any convenient manner, including widely separated microperforations and/or microperforations concentrated in one or more “target areas,” as shown for example in FIG. 1B. Note that FIGS. 1A through 2C are designated as being “prior art” because the inventive features of the present invention are not visible in the figures. However, the features that are visible in these figures, such as the overall shape of the base and lid, the inclusion of a sealant layer, and the locations of the microperforations, are applicable to embodiments of the present invention.

With reference to FIGS. 4A and 4B, in some embodiments of the disclosed method, a backing support 402 is temporarily positioned behind the base wall 200 or lid 202 of the container in the region to be microperforated by the micro-drill 400. The backing support 402 can be made from any convenient material, and can include a clearance hole 404 to avoid direct contact between the backing support 402 and the micro-drill 400.

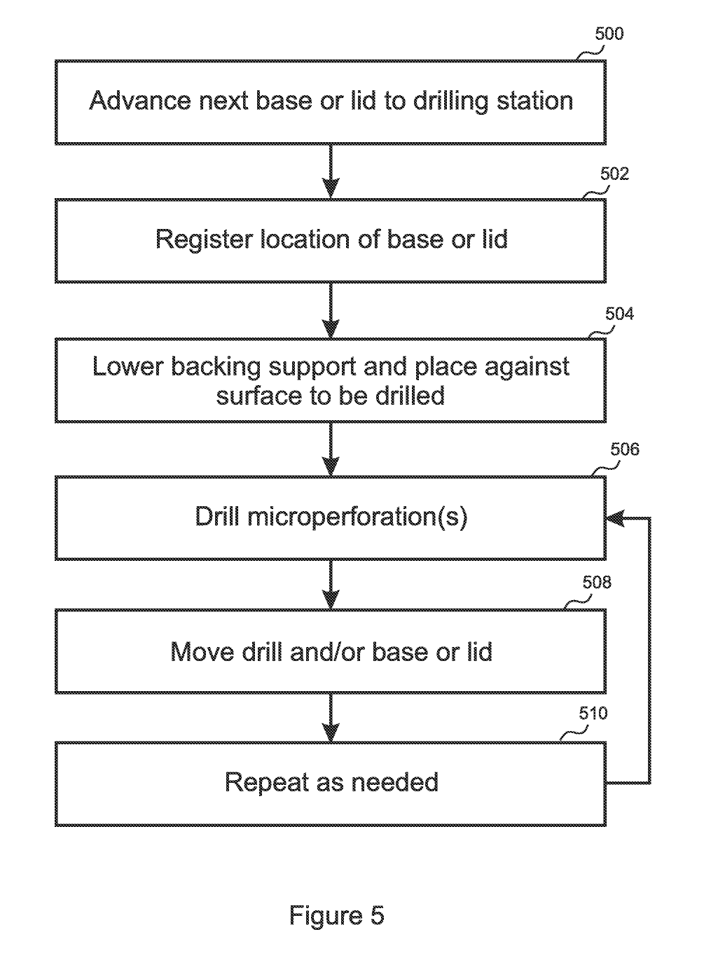

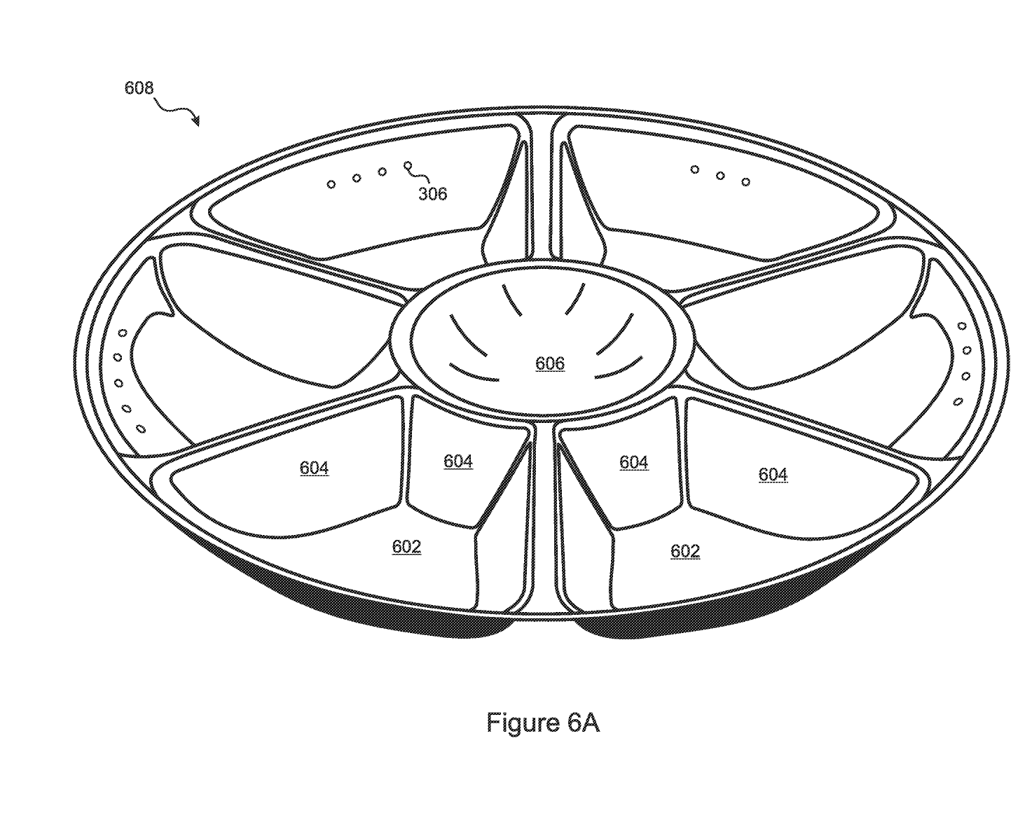

With reference to FIG. 5, in embodiments of the method of the present invention that are implemented in an automated assembly-line production environment, each container base 200 or lid 202 is brought to a drilling station 500, its position is “registered” (for example by a low power laser and optical sensor) 502, and the backing support is lowered into position 504 and placed against the surface to be perforated. The microperforation(s) is/are then drilled 506, either by a single drill or by a plurality of drills acting simultaneously. The drill(s) and/or container lid or base can be moved 508 after the initial drilling, and the drilling process can be repeated 510 so as to provide the desired number of microperforations.

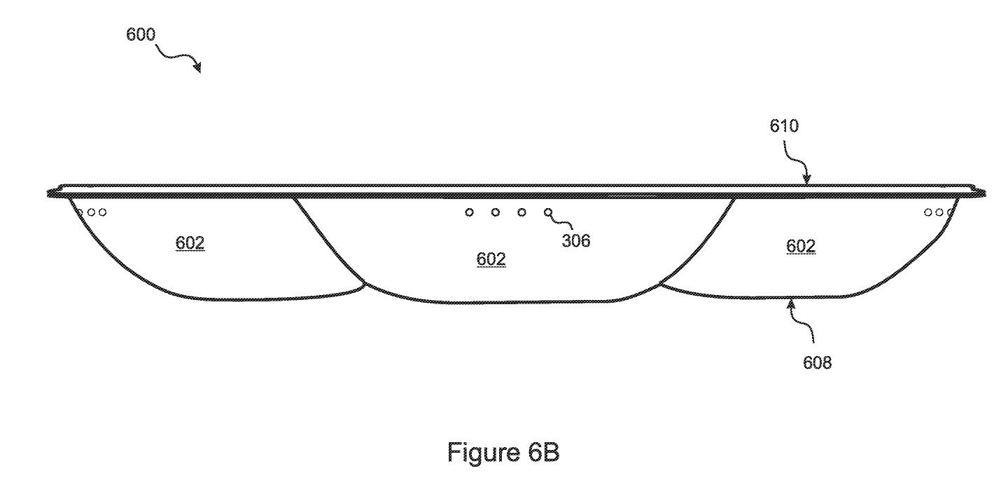

With reference to FIGS. 6A and 6B, embodiments 600 of the present invention include bases 608 that are divided into internal wells or compartments 602 that can be filled with differing contents. In some of these embodiments, the compartments 602 are separated by partitions 604 that rise to a level slightly below the lid 610, for example 1-3 mm below the lid 610, so that the contents are maintained in their respective compartments, but air is able to flow throughout the interior of the container 600. In other of these embodiments, the partitions 604 that divide the compartments 602 extend to the lid 620, so that upon initial packaging the partitions 604 are sealed to the lid 610 by the sealant layers 208, creating hermetically isolated compartments 602 that can be separately ventilated by microperforations 306, so that optimal modified atmospheres are established separately in each of the compartments 602. Compartments 606 intended to contain meat, cheese, dip, or some other content that does not benefit from respiration can be left without microperforations 306, so that they are hermetically sealed.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application.

This specification is not intended to be exhaustive. Although the present application is shown in a limited number of forms, the scope of the invention is not limited to just these forms, but is amenable to various changes and modifications without departing from the spirit thereof. One or ordinary skill in the art should appreciate after learning the teachings related to the claimed subject matter contained in the foregoing description that many modifications and variations are possible in light of this disclosure. Accordingly, the claimed subject matter includes any combination of the above-described elements in all possible variations thereof, unless otherwise indicated herein or otherwise clearly contradicted by context. In particular, the limitations presented in dependent claims below can be combined with their corresponding independent claims in any number and in any order without departing from the scope of this disclosure, unless the dependent claims are logically incompatible with each other.

I claim:

1. A rigid or semi-rigid container configured for modified atmosphere packaging of produce, the container comprising:
a base and a lid, the lid being removably engageable and reengagable with the base so as to form a seal therebetween, the base and lid both being formed from laminated panels having outer rigid or semi-rigid layers laminated to inner sealant layers, the sealant layers being sealable to each other so as to form a hermetically sealed junction between the lid and the base; and
at least one microperforation penetrating both laminated layers of one of the base and the lid, said microperforation having a length of at least 0.4 mm and a diameter between 20 microns and 300 microns, said diameter being uniform along a length of the microperforation within a tolerance of plus or minus 10%.

2. The container of claim 1, wherein the outer layer of the laminated panel include PET.

3. The container of claim 1, wherein the inner layer of the laminated panel includes at least one of polyacrylonitrile resin and polyester film.

4. The container of claim 1, wherein the diameter of the at least one microperforation is between 40 microns and 250 microns.

5. The container of claim 1, wherein the base of the container is divided by partitions into a plurality of compartments.

6. The container of claim 5, wherein a gap of at least 0.5 mm remains between tops of the partitions and the lid when the lid is engaged with the base.

7. The container of claim 5, wherein the sealant layers on tops of the partitions are hermetically sealed to the sealant layer of the lid when the lid is engaged and sealed with the base, and the compartments are thereby hermetically isolated from each other.

8. The container of claim 7, wherein a rate of gas exchange between each compartment and a surrounding ambient atmosphere is separately controlled according to a number and configuration of microperforations provided in the compartment.

9. The container of claim 8, wherein at least one of the compartments is hermetically isolated from the surrounding ambient atmosphere.

10. The container of claim 1, wherein the container includes a plurality of microperforations.

11. The container of claim 10, wherein the plurality of microperforations are located in at least one localized target area on at least one of the base or lid, a largest dimension of said target areas being no greater than 25% of a smallest of a height, a width, and a depth of said container.

12. A method for manufacturing a rigid or semi-rigid container configured for modified atmosphere packaging of produce, the method comprising:
providing a base and a lid, the lid being removably engageable and reengagable with the base so as to form a seal therebetween, the base and lid both being formed from laminated panels having outer rigid or semi-rigid layers laminated to inner sealant layers, the sealant layers being sealable to each other so as to form a hermetically sealed junction between the lid and the base; and
using a micro-drill to drill at least one microperforation through both laminated layers of one of the base and the lid, said microperforation having a length of at least 0.4 mm and said micro-drill having a diameter between 20 microns and 300 microns.

13. The method of claim 12, further comprising, before drilling said at least one microperforation, locating a rigid backing support behind at least a localized region of the base or lid where the microperforation is to be drilled so as to inhibit the base or lid from deforming during the drilling of the microperforation.

14. The method of claim 12, further comprising:
conveying the lid or base to a drilling station; and
registering a location of the lid or base, so that the location is accurately determined.

15. The method of claim 14, wherein registering the location of the lid or base includes using at least one of a laser and a light sensor.

16. The method of claim 12, further comprising drilling a plurality of microperforations using a plurality of micro-drills, each of the microperforation having a length of at least 0.4 mm, each of the micro-drills having a diameter between 20 and 300 microns.

17. The method of claim 12, further comprising:
moving at least one of the base or lid and the micro-drill; and
drilling at least one more microperforation.
